(19) United States
(12) Patent Application Publication
(10) Pub. No.: US 2015/0225145 A1
(43) Pub. Date: Aug. 13, 2015

(54) KITCHEN APPLIANCE FOR PLACEMENT ON A VESSEL; KITCHEN APPLIANCE SET, COMPRISING KITCHEN APPLIANCE AND VARIOUS FUNCTIONAL UNITS

(71) Applicant: FISSLER GMBH, Idar-Oberstein (DE)

(72) Inventors: Arno Thelen, Idar-Oberstein (DE); Andreas Hillenmeier, Ingelheim (DE)

(21) Appl. No.: 14/422,299

(22) PCT Filed: Jun. 10, 2013
(86) PCT No.: PCT/EP2013/061887

§ 371 Date: Feb. 18, 2015

(30) Foreign Application Priority Data
Aug. 27, 2012 (DE) 10 2012 107 862.9

(51) Int. Cl. B65D 51/24; B65D 43/06; A47J 43/25

(52) U.S. Cl. CPC B65D 51/24; A47J 43/25; B65D 43/06; B65D 2543/00296; B65D 2543/00277; B65D 2543/00305

(57) ABSTRACT

The disclosure relates to a kitchen appliance for placement on vessels having a substantially circular opening edge, having a plate-shaped base body made of a first material having a recess into which at least one type of functional unit can be temporarily introduced. The base body is formed to have a shell-like shape as well as a concave and a convex side. At least on the convex side of the shell-shaped base body, a contact surface made of a second material is attached in sections, wherein the second material effects a greater frictional force in contact with the material of the vessel than the first material.

### FIELD

The disclosure relates to a kitchen appliance for placement on vessels having a substantially round opening edge, comprising a base body having a recess, into which at least one type of functional unit can be temporarily introduced. Exchangeable functional units can thus be inserted into the recess for preparing and processing food, which can be slicers, graters, etc., for example. The disclosure thus also relates to a kitchen appliance set comprising such a kitchen appliance and various exchangeable functional units. The food, such as fruit and vegetables, comminuted by means of the kitchen appliance, for example, then drops directly from the respective functional unit into the vessel located therebelow. In the case of advantageous embodiments, the kitchen appliance can simultaneously also be used as a lid for the vessel.

### BACKGROUND

For example, patent specification DE 37 19 649 C2 discloses a kitchen appliance, which can simultaneously also be used as a lid for a vessel comprising a round opening edge. For this purpose, provision is made in a flat lid, which can be placed with its edge on a shell by means of friction fit, for a rectangular opening for receiving a slicer. However, the slicer can also be used independently from the lid, because it can be removed from the recess. The recess could then be closed by means of a plate, so as to use the lid purely as lid for a vessel, into which a food was sliced, for example beforehand.

This kitchen appliance and other conventional kitchen appliances, however, have the disadvantage that they are in each case only geared towards a certain diameter of the vessel, with which they are to be used, because provision must be made for means for holding the lid on the vessel in response to the preparation of the food. For example, the lid must not slip, when a food is moved horizontally on a slicer with power and pressure. For this purpose, provision is commonly made for mechanical elements, by means of which the lid is held on the vessel via a positive fit. The lid is thereby oftentimes provided with a notch, which engages with the opening edge of the vessel with a positive fit and which secures the lid against a radial displacement on the vessel in this manner. In a special case, a lid can also be equipped with a plurality of notches. Even though these kitchen appliances can thus simultaneously be used as slicer, grater and as lid, they are always geared towards the use with vessels of a certain size or even molding. They furthermore do not allow for any additional possible uses.

### SUMMARY

It is thus the task of the disclosure to provide an improved kitchen appliance for placement on vessels having a substantially round opening edge, which can be used as base unit for the use in various types of functional units. The kitchen appliance is to thereby be capable of being placed on vessels having different diameters as easily and as slip-resistant as possible.

The kitchen appliance according to the disclosure is suitable for being placed on vessels having a substantially circular opening edge and comprises a plate-shaped base body made of a first material having a recess into which at least one type of functional unit can be temporarily introduced.

According to the disclosure, the base body is formed to have a shell-like shape, wherein a base body is formed having a concave and a convex side, and at least on the convex side of the shell-shaped body, a contact surface made of a second material is attached at least in sections. The second material of the contact surface thereby effects a greater frictional force in contact with the material of the vessel than the first material of the base body.

The first material of the base body can be, for example, plastic, ceramics or metal, in particular stainless steel. These are materials, which are physiologically unproblematic in the kitchen area, which provide the kitchen appliance with a suitable surface characteristic and thereby with a good form stability. However, in response to direct contact between the material of the base body and a vessel, which includes a similar material, the kitchen appliance could slip on the opening edge of the vessel. This could be disadvantageous in particular when using functional units, such as slicers and graters, because horizontal forces, which would otherwise slide the kitchen appliance back and forth on the edge of a vessel, would need to be exerted with these functional units in response to processing food, such as fruit, vegetables or cheese.

A contact surface made of a second material, which, in material combination with the material of the vessel, generates a greater frictional coefficient than the material of the base body, is formed at least on the convex side of the shell-shaped base body. The frictional force generated in the case of the material combination contact surface/vessel is thus greater than in the case of the material combination base body/vessel. The kitchen appliance can thus be placed with its convex bottom side on a vessel having a round opening edge, wherein it is fixed more securely in this position than would be the case without the contact surface. In the case of a sufficiently large friction coefficient, the kitchen appliance can be secured very well against an unintentional slipping in response to the horizontal forces, which appear in particular in response to grating or slicing food.

Preferably, the second material of the contact surface is thereby a plastic, which is in particular a rubber-like plastic, which, in combination with hard plastic, ceramics or stainless steel, has a relatively high friction coefficient. For example, silicon elastomers, nitrile rubber (NBR) or a thermoplastic elastomer, such as the product Santoprene™, can be chosen hereby. In combination with the mentioned typical materials for vessels in the kitchen area, this group of materials effects a very high friction coefficient, so that the kitchen appliance can be fixed securely in its position on a vessel via the at least one contact surface. An independent shifting or slipping does not take place. In addition, these materials are washable and heat resistant, so that they are also suitable for the dishwasher, for example.

Due to the shell shape of at least a partial area of the kitchen appliance, the appliance can furthermore rest well in this area against a substantially circular opening edge of a vessel. It thereby has contact to the vessel all around, so that the high friction coefficient of the contact surface can also act all around, so as to fix the kitchen appliance in a certain position. In the case of contact surfaces made of rubber-like plastics, the kitchen appliance according to the disclosure can thus also be placed on a vessel so as to form a seal, in particular in response to cooking processes.

However, the vessels, on which the kitchen appliance is placed, do not necessarily need to have a completely circular opening edge thereby, but they can also encompass gaps, for example in the form of a pouring lip. Furthermore, the kitchen appliance does not need to be placed on a vessel as straight as possible, but it can also be placed at a slight angle. The dimensions of the contact surface on the convex bottom side of the kitchen appliance are thus preferably chosen in such a way that they have circumferential contact with a vessel edge, even when the kitchen appliance is positioned at an angle. If the radial expansion of the respective contact surface is embodied to be very large, this furthermore has the advantage that the kitchen appliance can be placed on vessels of varying sizes. In the case of large vessels of up to a certain diameter, the kitchen appliance then rests against the opening edge of the respective vessel, close to its circumference, while it rests more against the middle area of its base body in the case of smaller vessels. For this purpose, the bottom side of the base body, for example, can be covered almost completely with the contact surface.

The maximally possible diameter of the vessels is thereby determined by the diameter of the base body of the kitchen appliance, while the minimally possible diameter of the vessels is provided approximately by the position and the size of the recess, into which the different types of functional units can be introduced. Due to the fact that food is processed by means of the respective functional unit and falls into the vessel located below it, for example in the shape of slices, rasps, drops, etc., this vessel should advantageously be at least as large as the recess with the functional unit, so that the respective food can be caught completely by the vessel.

Graters, slicers, automatic drip systems, steamer inserts and/or juice extractors, for example, can be used as functional units. However, it is also possible to use the kitchen appliance without inserted functional unit as lid for a vessel, wherein the food located in the vessel can be seen and accessed through the recess. In this form of use, a mixer, for example, could be guided through the recess, so as to use the kitchen appliance as splash guard for food parts, which swirl around. The kitchen appliance could also be used as splash guard on a pan without an inserted functional unit.

A closing plate can furthermore be inserted into the recess, so that a closed lid results. This lid can also serve as splash guard and can also be placed on pots or pans for a cooking process. The closing plate can thereby be transparent or opaque. A transparent closing plate would again make it possible to see the food located therebelow. However, with a closing plate in the recess, the kitchen appliance could also simply be used as shell or storage for food, such as fruit and vegetables.

On its convex side, the kitchen appliance thereby preferably does not encompass any shaped elements for positioning the appliance on a vessel. Elements, such as notches, protrusions, stops or grooves, by means of which the kitchen appliance can be positioned in a certain radial position relative to the vessel, thus do not need to be present. The fixation of the kitchen appliance relative to the vessel thereby preferably takes place exclusively via the friction between the opening edge of the vessel and the contact surface of the kitchen appliance.

The shell shape of the base body can thereby be attained in different ways. For example, the base body is domed or cone-shaped in at least a first partial area, whereby the concave and the convex side of the base body are formed. A domed base body is thus more a bulbous shell, while the cone shape has straight walls, which slope towards the middle.

A domed base body is thereby preferably formed by the curved part of the surface of a spherical segment, wherein this spherical segment or this spherical section, respectively, is created when a plane intersects with a ball (spherical cap/spherical pig). Such a domed base body will thus also be identified hereinbelow as being spherical segment-shaped, wherein the radius of the spherical segment-shaped base body is chosen accordingly and can also be very large, so that an approximately cone-shaped form is attained. However, the spherical segment shape has proven to be particularly advantageous, because it always effects an optimum bearing surface to the respective vessel when the kitchen appliance is placed on a vessel having a circular opening edge. In response to rotating the kitchen appliance about an imaginary center of rotation or in response to eccentrically displacing the kitchen appliance on the vessel, respectively, this optimum bearing surface is maintained, which is significant in particular for a kitchen appliance, which has a sealing function.

The recess can then be introduced directly into the domed or cone-shaped first partial area of the base body. In an exemplary embodiment of the disclosure, however, the base body is flat in at least a second partial area, wherein the first partial area encloses this flat second partial area in a ring-shaped manner. The recess is then formed in the flat second partial area. A flat bottom surface, in which the recess is preferably located, is thus arranged in the center of the shell. This has the advantage that the functional units are not inserted into an inclined surface, but into a flat surface. In particular graters, slicers and/or closing plates can thus also be embodied with a flat upper side, so as to be able to be introduced into the base body so as to be flush therewith. The recess in the middle and thus at the lowest point of the kitchen appliance thereby in particular also has the advantage that food and in particular liquids slip or even flow automatically towards the recess.

However, it is not only possible to embody the base body so as to be flat in its center, but provision can also be made on the outer edge of the first partial area for areas, which are flat or which are formed otherwise. For example, an outer circumferential flat edge can exist or hooks and/or rings are formed on the edge, so as to be able to hang up the kitchen appliance. In an exemplary embodiment of the disclosure, the circumference of the base body, however, is circular and the first partial area reaches all the way to the circumference of the base body.

To be able to insert functional units easily and securely, the recess can be enclosed by at least one side wall, which protrudes on the convex side of the base body. An accommodation having a sufficient side stability is thus formed, and the at least one type of functional unit can be temporarily introduced within this side wall. To fix a functional unit within the recess, provision is made on the base body for means for temporarily fixing different functional units. In particular, these are latching means in the area of the recess, which can be embodied for example on the at least one side wall.

The side wall protruding on the convex side of the base body thereby has the advantage that flat functional units can be inserted into the recess so as to be flush therewith on the concave side. If this is not desired, but if protrusions and/or ledges may be present on the concave side of the base body, such a side wall, however, can also protrude on the concave side. In a further exemplary embodiment, the side wall can be forgone, wherein provision can then be made for other means so as to temporarily fix a functional unit within the recess. In particular, means, by means of which the functional unit can be snapped into place with the recess, can also be present at the functional unit itself. These are spring-loaded balls, for example, which, in response to introducing a functional unit, are pushed through the edge of the recess into countersinks to the extent that the functional unit can be pushed into the recess. As soon as the balls have passed the edge of the recess, they move back into their initial position due to spring force and snap into place below the edge of the recess. However, this type of fastening means can also be combined with circumferential side walls or with other elements at the recess, so that the balls snap into place with openings or grooves within these elements.

Size and arrangement of the at least one contact surface made of a material having a high friction coefficient can be chosen so as to vary. For example, a plurality of contact surfaces can be attached separated from one another on the convex side of the shell-shaped partial area in such a way that they form a ring, which is interrupted by the first material of the base body. The individual contact surfaces are to hereby be arranged in such a way that that the kitchen appliance can still be placed on the opening edge of the vessel in a stable manner. At least three contact surfaces, which are arranged on a circle at an angle of 120° relative to one another, lend themselves for this purpose. Even though the kitchen appliance then only rests against these contact surfaces on the opening edge of a vessel, this can be sufficient for a slip-resistant fixation, depending on the chosen material and the width of the contact surfaces. However, this embodiment requires for a sealing function of the kitchen appliance on the kitchen vessel to be forgone, because in particular steam and/or liquid can escape from the gaps between the individual contact surfaces.

In a further exemplary embodiment of the disclosure, at least one contact surface is formed by means of a continuously circumferential ring. With such a ring, the kitchen appliance rests completely against the opening edge of a vessel, which further increases the reliability against slipping due to the increase of the bearing surface, and which also provides for a leak tightness. So that the kitchen appliance can preferably be placed on vessels of varying sizes, this circumferential ring is so wide that, in the case of small and large vessels, the kitchen appliance always rests with the ring-shaped contact surface against the vessel edge.

In an exemplary embodiment of the disclosure, at least one contact surface extends from the convex side of the base body beyond the edge of the base body to the concave side of the base body. The contact surface thereby encloses the edge of the base body and thus forms a U-shaped edge protection. The ring can thereby completely enclose the edge circumferentially or can extend towards the concave side only in sections.

In this embodiment, at least one grab tab can be embodied on the circumferential ring on the concave side of the base body, in that the ring is widened in sections towards the center point of the base body. In the alternative or additionally, however, the ring can also encompass a thickening in sections on the concave side of the base body. For example, two grab tabs, which are located opposite one another, can thus be formed on the concave side of the base body. The kitchen appliance can be grabbed securely on these grab tabs, because the contact surface ensures that the fingers of a user do not slip on the material of the base body. In response to the use of the kitchen appliance, the grab tabs can furthermore provide heat protection as a lid for a pot or a pan, because the base body, which becomes hot in response to the cooking process, does not need to be touched directly. In the case of materials, such as silicon elastomers or NBR, the grab tabs typically have a higher thermal resistance than the base body, so that the kitchen appliance can be grabbed at the grab tabs, without resulting in burns on the fingers of a user. In the case of a contact surface, which encloses the edge of the base body completely, users are also protected from burning themselves on the edge of the kitchen appliance.

The disclosure also covers a kitchen appliance set, which comprises a kitchen appliance according to one of the described embodiments and at least one functional unit, which can be temporarily introduced into the recess of the kitchen appliance. The shape and size of the recess and of the different functional units are thus compatible with one another and the kitchen appliance offers specific advantages for various functional units.

The inserted functional unit can be a grater, a slicer, an automatic drip system, a steamer insert, a juice extractor and/or a closing plate, for example. As already mentioned, the kitchen appliance according to the disclosure in particular offers the advantage in the case of graters and slicers that, due to its embodiment, the kitchen appliance can be placed on a vessel in a slip-resistant manner. The kitchen appliance does not slip even in response to strong horizontal movements of food, such as fruit, vegetables or cheese, on a grater, for example, and can thus be used easily and securely. Due to a relatively large “radius” of the kitchen appliance, which is concave on one side, a suitable work surface also forms outside of the inserted functional unit, so that the respective food can be pushed back and forth in the flat shell with vertical pressure and is thereby guided across the cutting edges of a grater, for example, again and again. For this purpose, a grater is preferably inserted into the recess so as to be flush therewith, so that the grater and the surface of the concave side of the base body form an approximately continuous surface, from which only the cutting blade of the grater protrudes. The same applies to slicers or to other functional units for comminuting food.

After comminuting a food, the respective used functional unit can be removed from the recess and food scraps, which have collected in the shell, can be pushed easily towards the recess and can be guided through it into the vessel. The same applies to functional units, such as juice extractors. Even though they are not inserted into the recess so as to be flush therewith, but protrude from the concave side of the kitchen appliance, they can also be removed after the juice extracting process and juice, which did not immediately flow into the vessel, but which collected in the shell, can flow into the vessel through the recess. As little liquid as possible is lost hereby.

For example, wine can be added to the content of a pot so as to be metered by means of an automatic drip system, wherein such an automatic drip system also protrudes on the concave side of the kitchen appliance. In contrast, a steamer insert can be inserted into the recess so as to be flush therewith, so that the food, which is to be steamed, can be distributed in the shell-shaped base body of the kitchen appliance. Water is then heated in the vessel below the kitchen appliance, so that water vapor can flow through the steamer insert to the food to be steamed. Provision can possibly also be made for a lid, by means of which the food to be steamed is covered, so as to keep the water vapor in the area of the food to be steamed. In the case of this use of the kitchen appliance, it is also advantageous for the kitchen appliance to be capable of being placed tightly on a vessel with the contact surface on the circumference, because the water vapor can then not escape through gaps between the vessel and the attachment, but flows through the openings of the steamer insert.

With minimal use of material, this results in a highly versatile spectrum of application options for the user. In addition, the kitchen appliance according to the disclosure is simple to use and can also be cleaned easily in spite of its many possible uses. The disc-shaped kitchen appliance can be placed into the dishwasher upright, like a plate, and does not encompass any gaps, crannies, cavities, etc., which cannot be accessed, in which food scraps can collect in a disadvantageous manner such that they can only be removed with difficulty. The used functional units can also be cleaned separately from the kitchen appliance in the dishwasher.

### BRIEF DESCRIPTION OF THE DRAWINGS

Further advantages, characteristics and advantageous further developments of the disclosure follow from the below description of preferred exemplary embodiments by means of the illustrations.

FIG. 1a shows a first three-dimensional top view onto an exemplary embodiment of the kitchen appliance according to the disclosure, without inserted functional unit;

FIG. 1b shows a three-dimensional bottom view onto a kitchen appliance according to FIG. 1a;

FIG. 1c shows a second three-dimensional top view onto an exemplary embodiment of the kitchen appliance according to the disclosure, with inserted functional unit (grater);

FIG. 2a shows a cross section through a vessel of a first size having an attached kitchen appliance according to a first embodiment;

FIG. 2b shows a cross section through a vessel of a first size having an attached kitchen appliance according to a second embodiment;

FIG. 3 shows a cross section through a vessel of a second size having an attached kitchen appliance;

FIG. 4 shows an enlarged detailed view of the contact between the contact surface of the kitchen appliance and the opening edge of a vessel;

FIG. 5 shows a three-dimensional view of a vessel having an attached kitchen appliance having an inserted functional unit; and

FIG. 6 shows a cross section through a vessel having a kitchen appliance placed at an angle and a pouring gap.

### DETAILED DESCRIPTION OF THE DRAWINGS

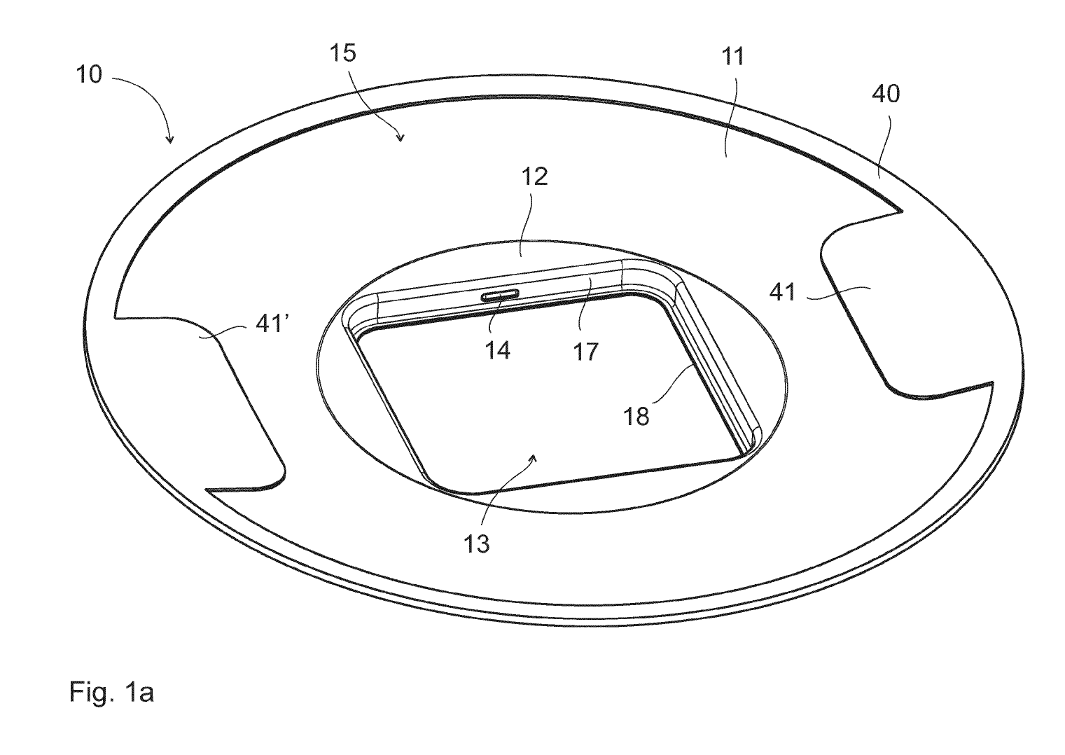

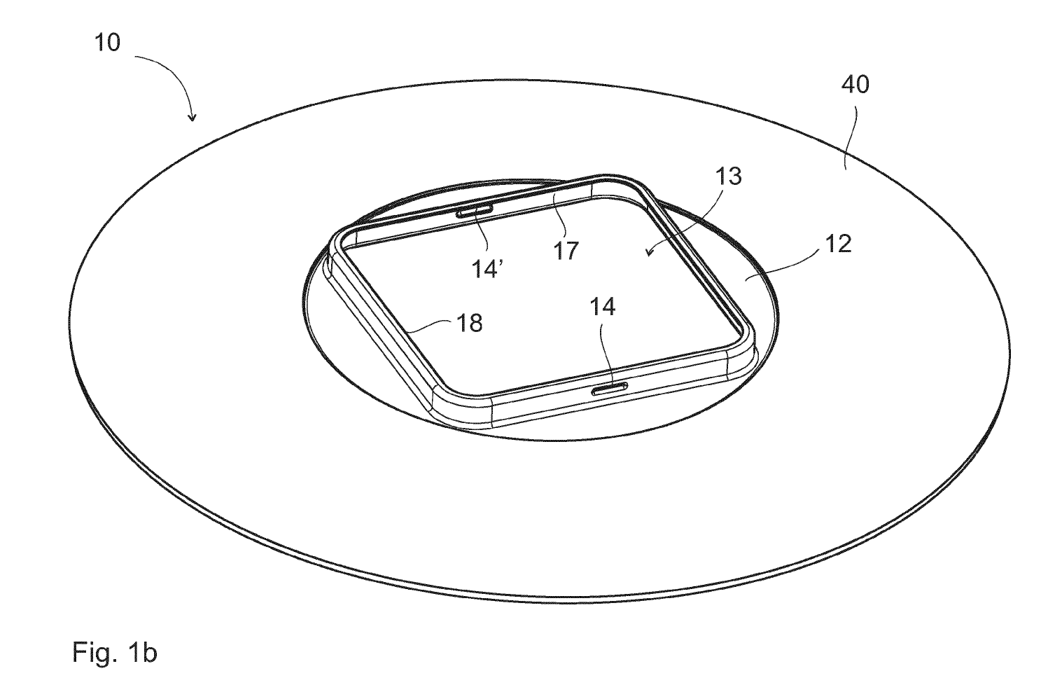

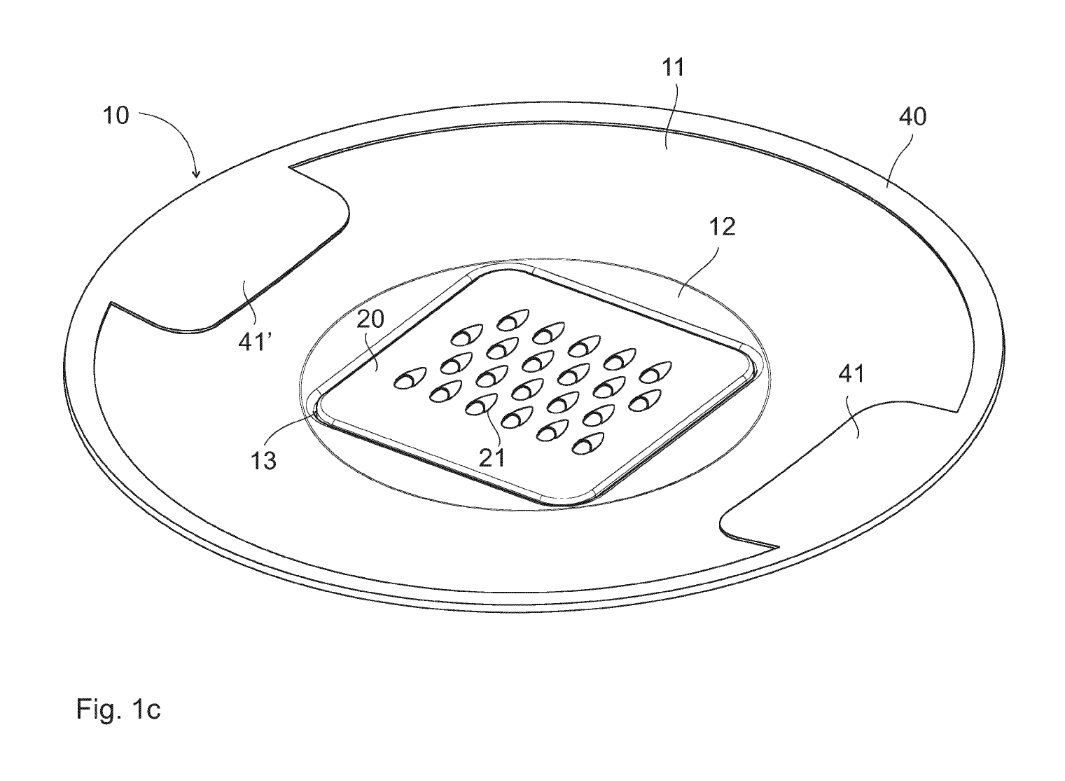

FIG. 1a shows an exemplary embodiment of the kitchen appliance 10 according to the disclosure in a first three-dimensional view. The kitchen appliance 10 is substantially formed by means of a plate-shaped, circular base body 15, which is formed in a shell-shaped manner. A concave and a convex side of the base body thus result, wherein the kitchen appliance 10 is embodied to be placed with the convex side on a vessel having a substantially circular opening edge.

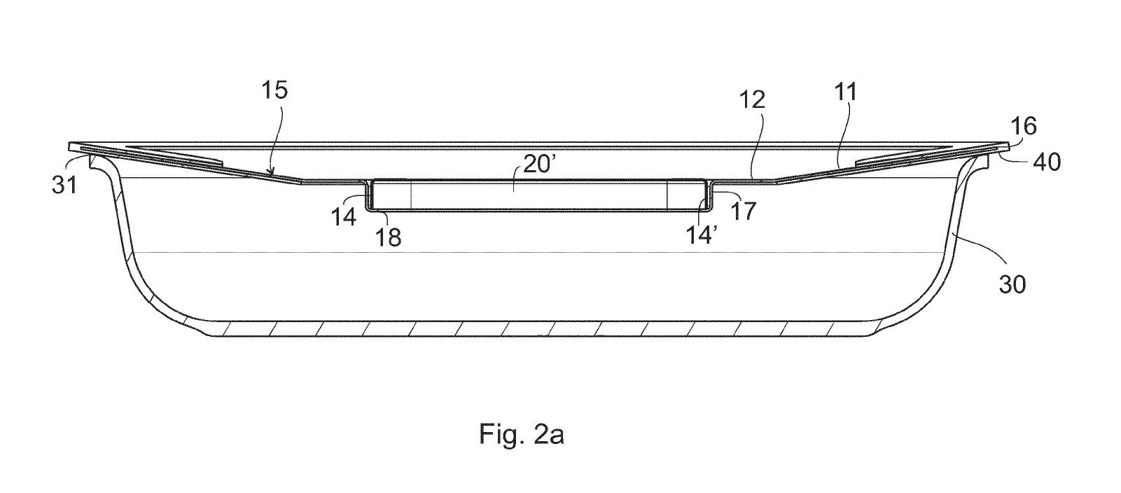

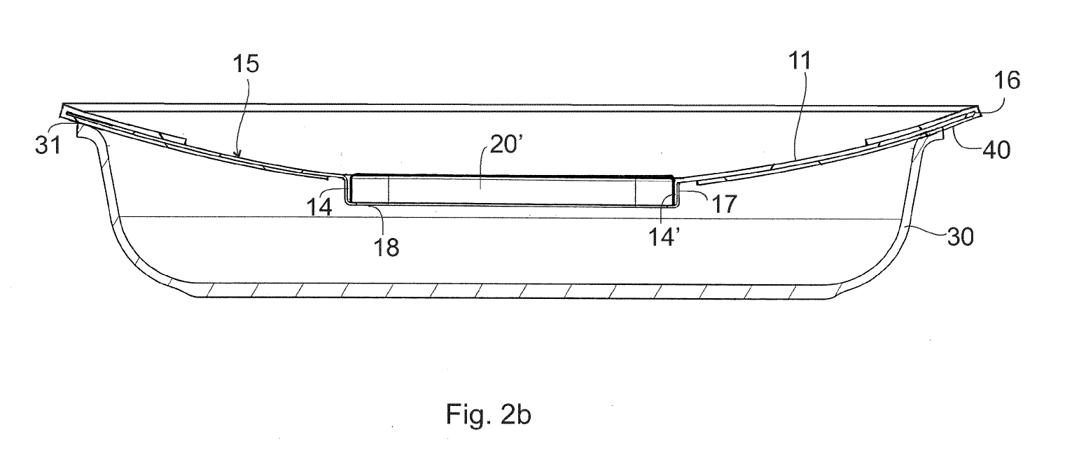

In the exemplary embodiments of the figures, the shell-shape of the kitchen appliance 10 is attained by means of a base body 15, which is spherical segment-shaped at least in sections. However, the base body 15 is thereby embodied like a very flat shell, wherein the radius of the spherical section is so large that the shape of the base body 15 also appears approximately in a cone-shaped manner in the figures. A shell, which is so flat, has the advantage that, in response to being placed on a vessel having a very large opening edge, the convex bottom side of the kitchen appliance 10 does not protrude so deeply into the vessel that it reduces the space for the food, which is to be received from the top, too much. FIG. 2b illustrates an embodiment having a smaller radius, in which the advantageous spherical segment shape can be identified more clearly.

Provision is made in the center of the base body 15 for a recess 13, which is enclosed by at least one side wall 17, which protrudes on the convex side of the kitchen appliance 10. This can also be gathered from the bottom view of FIG. 1b. However, in the area of the recess 13, the base body 15 is not embodied so as to be spherical segment-shaped, but so as to be flat. A spherical segment-shaped partial area 11 of the base body 15 thus surrounds this flat partial area 12 in a ring-shaped manner, so that a flat shell having a flat bottom is formed by means of the two partial areas 11 and 12.

The flat partial area 12 of the base body 15 is embodied so as to be round, for example. A rectangular recess 13, which, however, has rounded corners, is formed in this flat partial area 12. This rounding of the corners prevents sharp edges and facilitates the cleaning of the kitchen appliance. The transition from the flat partial area 12 into the side wall 17 of the recess 13 is also embodied so as to be rounded. The recess 13, however, can also have any other shapes and can also be embodied so as to be circular, oval, etc.

A respective functional unit (not illustrated) can be introduced into the recess 13, wherein the base body 15 encompasses means for temporarily fixing the functional unit to the base body 15. These are latching means, for example, wherein a latching nose or latching bead 14 is in each case formed in the illustrated exemplary embodiment on opposite sides on the inner surface of the side wall 17. This latching bead 14 protrudes into the interior of the recess 13 and the complementary formed area of a functional unit is embodied accordingly in such a way that it snaps into place with the latching bead 14 under pressure. A functional unit is held in the recess 13 in this manner, but can also be pulled or pushed out of the recess 13 again by exerting a certain tractive force from the top or a compressive force from the bottom, respectively.

However, provision can also be made for any other means for fixing functional units within or at least in the area of the recess 13. For example, these can be bores, grooves, tabs, slits, pins, hooks, etc., which interact with corresponding elements at the functional units. However, fastening means at the circumferential side wall 17 of the recess are particularly advantageous, because they do not change the surface of the flat partial area 12, and thus do not obstruct grating and slicing processes, for example. The use of bayonet closures is also possible in particular in the case of circular recesses, wherein a functional unit, which is also circular, can then be inserted into the recess and can be turned in such a way that the bayonet closure locks.

The base body 15 can be made of different materials, wherein in particular plastics, such as hard plastic, metal and ceramics are possible. Stainless steel is used in an exemplary embodiment of the disclosure, because this is unproblematic physiologically in the kitchen area and provides the kitchen appliance with a good form stability. The different partial areas 11 and 12 of the base body 15 and the recess 13 made of stainless steel can furthermore be formed in a relatively simple manner.

A significant aspect of the disclosure is the at least one contact surface 40 at least on the bottom side, that is, on the convex side of the base body 15. In the exemplary embodiment illustrated in FIG. 1a, this is a completely circumferential ring 40, which extends from the convex side across the circumference to the concave side of the base body 15. It thus encloses the edge 16 in a U-shaped manner and thereby rests against the base body 15 in a flat manner all-around.

Preferably, a rubber-like plastic, such as a silicon elastomer or nitrile rubber is chosen as material for the contact surface 40. A thermoplastic elastomer, such as the product Santoprene™ would also be suitable. As material combination together with the typical materials for vessels, these materials offer a high friction coefficient in the kitchen area and are particularly suitable for embodying a contact or friction surface, respectively. Such a contact surface can furthermore be attached to the base body 15 by means of known production techniques, such as spraying and pressing methods. In addition or in the alternative, mechanical connections are also possible.

On the convex side of the base body 15, the contact surface 40, for example in the shape of a silicon ring, thereby preferably reaches almost all the way to the flat partial area 12 and thus to the recess 13. In contrast, the ring only reaches around the edge of the base body 15 to the extent that said ring closes the base body securely on the concave side of the base body 15.

On the concave side of the base body 15, however, the ring 40 can be widened in sections towards the middle of the base body 15. At least one grab tab is formed hereby, as it is seen in the top view of FIG. 1a. In this exemplary embodiment, two opposite grab tabs 41 and 41′, at which the kitchen appliance 10 can be grabbed by a user, are embodied by means of the widening of the ring 40 in sections. At these locations, the kitchen appliance 10 can also be pushed downwards onto a vessel by means of the thumbs.

FIG. 1b shows a bottom view onto a kitchen appliance according to FIG. 1a, wherein a functional unit is also not inserted into the recess 13. The circular, flat partial area 12 of the base body, in which the recess 13 is formed, can thus be seen. The spherical segment-shaped inclined partial area 11 encloses this flat area 12, wherein it can be gathered from FIG. 1b that said spherical segment-shaped inclined partial area is covered completely by the contact surface 40 on the bottom.

The second latching bead 14′, which is located opposite the first latching bead 14 on the inner side of the side wall 17, can also be gathered from FIG. 1b. On the bottom side of the kitchen appliance 10, the side wall 17 protrudes from the shell-shaped base body, and in the exemplary embodiment of FIG. 1b, the edge 18 of the side wall 17 is embodied so as to be curved inwardly. A bearing or stop surface, receptively, for the functional unit, which is pushed in from the other side, results hereby. Sharp edges, which could otherwise lead to injuries, are furthermore avoided in this manner.

FIG. 1c shows a three-dimensional top view onto a kitchen appliance 10 having an inserted functional unit, which is a grater 20 having a plurality of cutting blades 21. As is the recess 13, the grater 20 is embodied so as to be rectangular having rounded edges and is inserted into the recess 13 so as to be flush therewith, so that, together with the flat partial area 12, it forms a continuous surface, from which only the cutting edges 21 protrude. The kitchen appliance 10 can now be placed on a vessel and the user can possibly hold it with one hand on a grab tab 41 41′, while the user guides fruit, vegetables or cheese across the grater 20 with the other hand. The food grated in this manner then falls down into the respective vessel on the bottom side.

FIG. 2a shows the kitchen appliance 10 placed on a vessel 30 in a cross section, whereby it is a vessel 30 having a relatively large diameter. For example, this can be a pan. The kitchen appliance 10 rests against the opening edge 31 of the vessel 30 with its ring-shaped contact surface 40, wherein this takes place in the outer area. On the convex bottom side of the base body 15, the contact surface 40 thereby extends from the flat partial area 12 across the spherical segment-shaped or cone-shaped partial area 11, respectively, and across the outer edge 16 of the base body 15 all the way to the concave upper side of the base body 15, so that the contact surface 40 encloses the circumference 16 of the base body in a U-shaped manner.

As functional unit, a closing plate 20′, which is embedded so as to be flush with the surface of the base body 15 or of the flat partial area 12, respectively, is inserted in the recess in the flat partial area 12. Elements of the closing plate 20′ are thereby snapped in place into the two latching beads 14 and 14′ with a positive fit, so that the closing plate 20′ is held in the recess and rests against the edge 18 of the side wall 17, which is curved inwards. The upper side of the closing plate 20′ forms an approximately flat surface with the inner surface of the base body 15. In this application of the kitchen appliance 10, the latter can be used for example as lid and/or splash guard for the vessel 30. With the contact surface, the kitchen appliance 10 can thereby rest against the opening edge 31 of the vessel 30 all-around and can also seal therewith.

FIG. 2b shows the same vessel having an attached kitchen appliance, in the case of which the spherical segment shape of the first partial area 11 of the base body 15 can be seen more clearly due to a smaller radius. However, the radius should also not be chosen to be so small that the kitchen appliance 10 protrudes too far into the interior of the vessel 30 and even touches food located therein in the case of vessels, which have such a large size. In this embodiment, the spherical segment-shaped partial area 11 furthermore protrudes directly all the way to the recess 13, so that a flat second partial area is not formed.

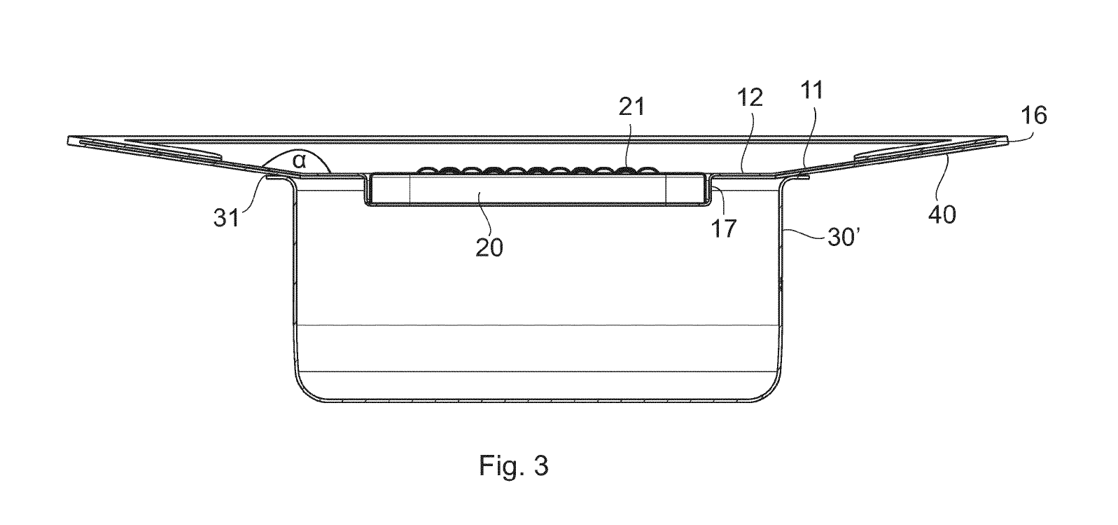

An application, in the case of which a functional unit in the form of a grater 20 having a cutting edge 21 is again placed into the recess 13, can be gathered from FIG. 3. The base body of the grater 20 is also embedded in the recess 13 so as to be flush with the inner side of the base body 15, but at least one cutting edge 21 of the grater 20 protrudes from this plane. Fruit, vegetables and/or cheese can thus be moved back and forth within the shell by means of pressure, wherein parts of the respective food are cut off by means of the cutting edge 21 and fall downwards into the vessel 30′. The respective food can thereby also be moved beyond the flat area 12 within the inclined area 11, wherein the angle a between the inclined area 11 and the flat area 12 on the concave side of the base body 15 is chosen to be very large, so as to provide a transition between the two areas, which is as smooth as possible.

In FIG. 3, the kitchen appliance 10 is placed on a vessel 30′ having a relatively small diameter, but the kitchen appliance 10 according to the disclosure can also be placed and positioned securely on this vessel size, because the contact surface 40 covers the convex side of the kitchen appliance 10 approximately completely, so that almost the entire bottom side is suitable as friction surface having good adhesive characteristics.

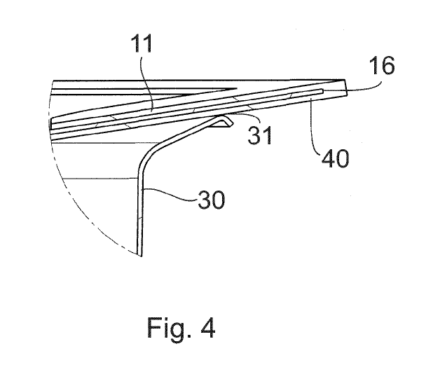

With regard to this, FIG. 4 shows an enlarged view of the contact between the opening edge 31 of a vessel 30 and the contact surface 40 of the kitchen appliance 10. The edge 31 of the vessel 30 does thereby not need to have a specific shape, which is adapted to the incline or the radius of the shell-shaped kitchen appliance, for example, but the kitchen appliance 10 simply rests against the highest point or against the highest circumferential edge of the vessel 30, respectively.

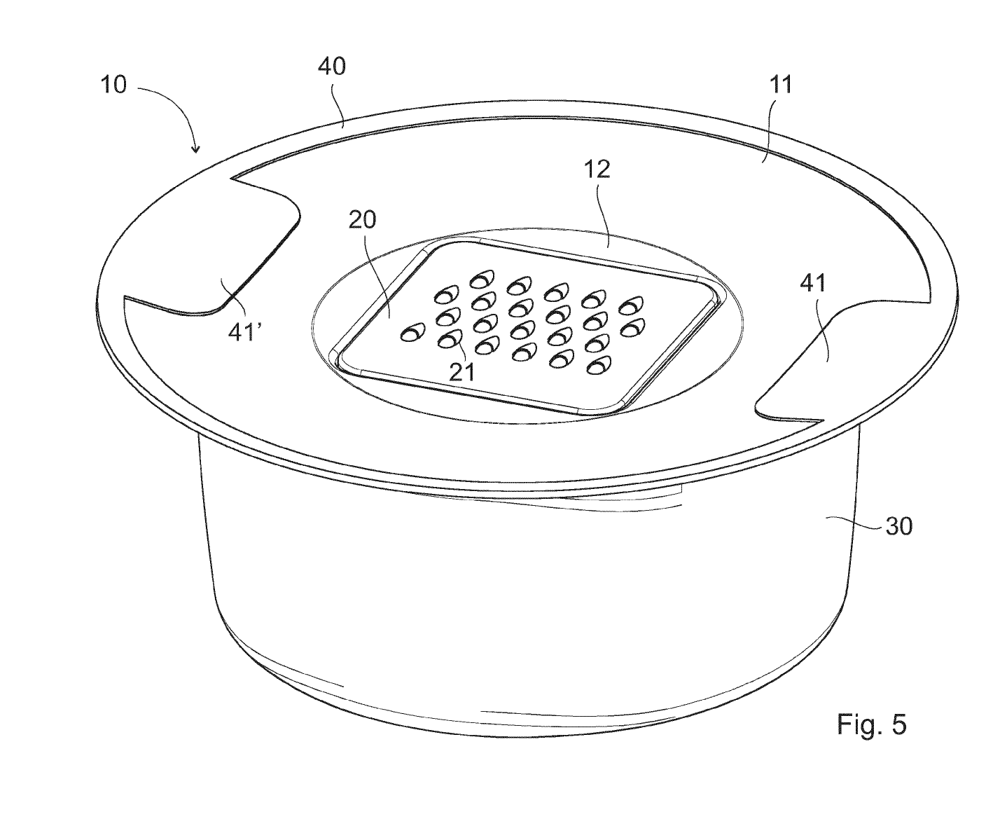

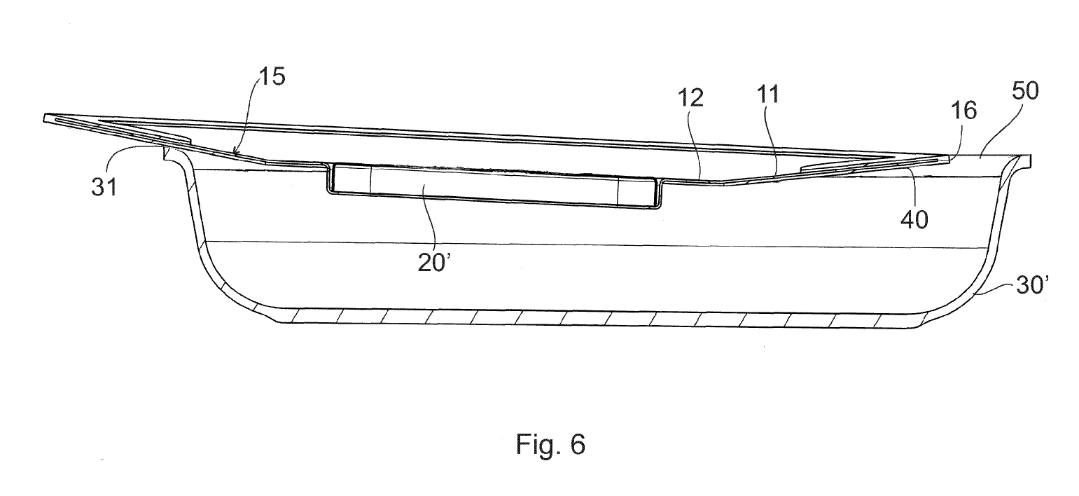

The arrangement of the kitchen appliance 10 on a vessel 30 of average size can once again be gathered from the three-dimensional view of FIG. 5. As functional unit, a grater 20 is thereby inserted into the recess 13 once again. However, the kitchen appliance 10 is secured on a vessel against slipping not only in a horizontal position, in which the disc-shaped kitchen appliance 10 is placed on the vessel in a substantially straight and centered manner and rests completely against the opening edge of the vessel. Instead, the kitchen appliance 10 can also be placed at an angle or can be pushed in a well-directed manner from a straight into an inclined position, respectively. This can take place in a stage-less manner and such an eccentric position is shown in FIG. 6 in an exemplary manner. In this inclined position, a pouring gap 50, through which liquid, for example, can be poured from the vessel 30, results between the opening edge 31 of the vessel 30 and the contact surface 40 on the edge 16 of the kitchen appliance 10. However, due to its preferably spherical segment-shaped base body, the kitchen appliance 10 thereby rests against the remaining edge of the vessel 30 so securely that it does not slip and that the width of the gap 50 can be maintained so as to be constant without any problems. If necessary, the thumb can be used to slightly push the kitchen appliance 10 on the side onto the edge 31 of the vessel.

1. A kitchen appliance for placement on vessels having a substantially circular opening edge, comprising a plate-shaped base body made of a first material having a recess into which at least one type of functional unit can be temporarily introduced, wherein the base body is formed to have a shell-like shape whereby a base body having a concave and a convex side is formed, and that at least on the convex side of the shell-shaped body, a contact surface made of a second material is attached at least in sections, wherein the second material of the contact surface thereby effects a greater frictional force in contact with the material of the vessel than the first material of the base body.

2. The kitchen appliance according to claim 1, wherein the first material is plastic, ceramics or metal, in particular stainless steel.

3. The kitchen appliance according to claim 1, wherein the second material is a plastic.

4. The kitchen appliance according to claim 1, wherein the shell-shaped base body is domed or cone-shaped in at least a first partial area, whereby the concave and the convex side of the base body are formed.

5. The kitchen appliance according to claim 4, wherein the shell-shaped base body is spherical segment-shaped in the at least one first partial area.

6. The kitchen appliance according to claim 1, wherein the base body is flat in at least a second partial area, wherein the first partial area encloses this flat second partial area in a ring-shaped manner, and that the recess is formed in the flat partial area.

7. The kitchen appliance according to claim 1, wherein the recess is enclosed by at least one side wall, which protrudes on the convex side of the base body, wherein the at least one type of functional unit can be temporarily introduced within this side wall.

8. The kitchen appliance according to claim 1, wherein a provision is made on the base body for means for temporality fixing different functional units.

9. The kitchen appliance according to claim 4, wherein the circumference of the base body is circular and the first partial area reaches all the way to the circumference of the base body.

10. The kitchen appliance according to claim 1, wherein a plurality of contact surfaces are attached separated from one another on the convex side of the base body in such a way that they form a ring, which is interrupted by the first material of the base body.

11. The kitchen appliance according to claim 1, wherein the at least one contact surface is formed by means of a continuously circumferential ring.

12. The kitchen appliance according to claim 1, wherein the at least one contact surface extends from the convex side of the base body beyond the edge of the base body to the concave side of the base body.

13. The kitchen appliance according to claim 11, wherein at least one grab tab is embodied on the circumferential ring on the concave side of the base body, in that the ring is widened in sections towards the center point of the base body or encompasses a thickening in sections.

14. A kitchen appliance set, comprising a kitchen appliance according to claim 1 and further including at least one functional unit, which can be temporarily introduced into the recess of the kitchen appliance.

15. The kitchen appliance set according to claim 14, wherein the functional unit is a grater, a slicer, an automatic drip system, a steamer insert, a juice extractor or a closing plate.

16. The kitchen appliance according to claim 1, wherein the second material is a silicon elastomer or a nitrile rubber.
